(19) United States
(12) Patent Application Publication
(10) Pub. No.: US 2016/0142219 A1
(43) Pub. Date: May 19, 2016

(54) eMBMS Multicast Routing for Routers

(71) Applicant: QUALCOMM Incorporated, San Diego, CA (US)

(72) Inventors: Chaitanya Pratapa, Hyderabad (IN); Poonam Mishra, Hyderabad (IN); Rohit Tripathi, San Diego, CA (US); Siddharth Gupta, San Diego, CA (US); Gaurav Gopal Kathuria, San Diego, CA (US)

(21) Appl. No.: 14/540,068

(22) Filed: Nov. 13, 2014

(51) Int. Cl. H04L 12/18; H04L 12/741

(52) U.S. Cl. CPC H04L 12/18; H04L 45/74

(57) ABSTRACT

Systems, methods, devices, and non-transitory processor-readable storage media of the various embodiments enable a software enabled access point (“softAP”) computing device to route evolved Multimedia Broadcast Multicast Service (“eMBMS”) multicast (“MCAST”) traffic to connected local area network (“LAN”) client devices. In an embodiment, a self-assigned Internet Protocol (“IP”) address may be assigned to the wide area network (“WAN”) interface of the softAP computing device where eMBMS MCAST traffic may be received and an MCAST routing daemon/utility of the softAP computing device may enable MCAST forwarding from the WAN interface to the LAN interface of the softAP computing device. In an embodiment, an MCAST routing daemon/utility may be modified to accept an alternate network comprising all source IP addresses.

### BACKGROUND

Numerous techniques and protocols are utilized to enable computing devices to connect to and communicate over packet-switching, wide area networks (“WANs”). For example, computing devices may connect to evolved Multimedia Broadcast Multicast Service (“eMBMS”) networks (i.e., Long Term Evolution (“LTE”) networks) established according to the 3rd Generation Partnership Projects (“3GPP”) Technical Standard (“TS”) 26.346 Release 11 to receive eMBMS multicast (“MCAST”) traffic.

Current router devices (e.g., a mobile access point (“mobileAP”) device, a software-enabled access point (“softAP”) device, etc.), including eMBMS modems for connecting to eMBMS networks and receiving eMBMS MCAST traffic, cannot route eMBMS MCAST traffic to client devices connected to a local area network (“LAN”) established by the router devices.

Two major problems prevent eMBMS MCAST traffic routing to connected LAN clients by current router devices that include eMBMS modems. First, currently eMBMS computing devices (e.g., user equipments (“UEs”)) are not assigned unicast Internet Protocol (“IP”) addresses by eMBMS networks; consequently current router devices that include eMBMS modems are not assigned unicast IP addresses. The lack of an assigned unicast IP address prevents the MCAST routing daemons and utilities of current router devices that include eMBMS modems from installing MCAST rules to route eMBMS MCAST traffic to LAN clients. Second, eMBMS MCAST packets source addresses may be any valid Internet Protocol version 4 (“IPv4”), but the MCAST routing daemons/utilities available in the current router devices' kernels that support forwarding of MCAST packets only distribute packets whose source address belongs to the same subnet of the interface in which the eMBMS MCAST packets are received. This restriction on distributing packets to those whose source address belongs to the same subnet of the interface in which the eMBMS MCAST packets are received prevents eMBMS MCAST traffic from being sent to LAN clients by the current MCAST routing daemons/utilities of current router devices that include eMBMS modems because in an eMBMS session the source of the eMBMS MCAST traffic will not be in the same subnet as the WAN interface of current router devices that include eMBMS modems.

### SUMMARY

The systems, methods, devices, and non-transitory processor-readable storage media of the various embodiments enable a software enabled access point (“softAP”) computing device to route evolved Multimedia Broadcast Multicast Service (“eMBMS”) multicast (“MCAST”) traffic to connected local area network (“LAN”) client devices. In an embodiment, a self-assigned IP address may be assigned to the wide area network (“WAN”) interface of the softAP computing device where eMBMS MCAST traffic may be received, and an MCAST routing daemon/utility of the softAP computing device may enable MCAST forwarding from the WAN interface to the LAN interface of the softAP computing device. In an embodiment, the self-assigned IP address may be any valid static or dynamic IP address. In an embodiment, the MCAST routing daemon/utility executing in a processor of the softAP computing device may identify the WAN interface for MCAST routing to LAN clients by installing MCAST routing rules in the kernel executing in a processor of the softAP computing device. In various embodiments, an MCAST routing daemon/utility may be modified to skip source validation enabling all eMBMS MCAST traffic to be forwarded to LAN clients regardless of the source address of the eMBMS MCAST traffic. In an embodiment, an MCAST routing daemon/utility may be modified to accept an alternate network comprising all source IP addresses. In an embodiment, the alternate network may be 0.0.0.0/0, which may include all source IP addresses. In an embodiment, a softAP computing device implementing embodiment methods may be a mobile computing device, which may benefit from the embodiment methods due to frequent changes in WAN and LAN connections that may occur when the device is moving.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a component block diagram of a communication system including a computing device functioning as a software enabled access point (“softAP”) for various devices according to various embodiments.

FIG. 2 is a component block diagram of modules within a computing device configured to operate as a softAP according to an embodiment.

FIGS. 3A, 3B, and 3C are process flow diagrams illustrating an embodiment method for a computing device configured to operate as a softAP to assign a self-assigned IP address to a WAN interface, install MCAST routing rules, and route eMBMS MCAST traffic to a LAN interface from the WAN interface.

FIG. 4 is a data structure diagram illustrating example elements of an MCAST routing table according to an embodiment.

FIG. 5 is a process flow diagram illustrating an embodiment method for a computing device configured to operate as a softAP to validate eMBMS MCAST traffic.

FIG. 6 is a component block diagram of a computing device suitable for use in the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “computing device” are used herein to refer to any one or all of cellular telephones, smart-phones, web-pads, tablet computers, Internet enabled cellular telephones, Wi-Fi enabled electronic devices, fixed or mobile eMBMS receivers, laptop computers, personal computers, and similar electronic devices equipped with at least a processor and configured with an evolved Multimedia Broadcast Multicast Service (“eMBMS”) (i.e., Long Term Evolution (“LTE”)) modem to establish a wide area network (“WAN”) connection with an eMBMS network and/or a network transceiver to establish a local area network (“LAN”) connection.

The terms “software enable access point computing device” or “softAP computing device” or “access point router” are used herein to refer to mobile or fixed computing devices configured to execute various software, applications, routines, and/or operations for operating as a routers capable of establishing WAN connections (e.g., eMBMS connections) and LAN connections (e.g., Wi-Fi connections) for enabling client devices to communicate with the WAN. For example, a softAP computing device may be a cellular network communication device (e.g., a smartphone, hotspot device, etc.) configured to operate as a wireless router (e.g., a Wi-Fi router) for providing client devices access to a cellular wide area network (e.g., an eMBMS network). The various embodiments may be particularly useful for mobile softAP computing devices.

The systems, methods, devices, and non-transitory processor-readable storage media of the various embodiments enable a software enabled access point (“softAP”) computing device to route eMBMS multicast (“MCAST”) traffic to connected LAN client devices. In the various embodiments, a router configuration module of a softAP computing device having an eMBMS modem may interface with an MCAST routing daemon or MCAST routing utility (referred to herein generally as an MCAST routing daemon/utility) of the softAP computing device (e.g., pimd, mrouted, etc.) and a kernel executing in a processor of the softAP computing device (e.g., an operating system kernel, such as Linux, Android, iOS, and/or Windows kernel) to enable the softAP computing device to route eMBMS MCAST traffic from a WAN interface to a LAN interface and onto one or more connected LAN client devices.

In an embodiment, a self-assigned Internet Protocol (“IP”) address may be assigned to the WAN interface (e.g., a wireless WAN (“WWAN”) interface) of the softAP computing device in which eMBMS MCAST traffic may be received and an MCAST routing daemon/utility of the softAP computing device may enable MCAST forwarding from the WAN interface to the LAN interface of the softAP computing device. As used herein, a self-assigned IP address may be an IP address assigned by a softAP computing device as opposed to an IP address assigned to the softAP computing device by an eMBMS network. In other words, while the self-assigned IP address may be an actual IP address, it may be considered a “pseudo” IP address in that the self-assigned IP address is not be provided to the softAP computing device by the eMBMS network, and therefore may not be recognized by an eMBMS network. In an embodiment, a router configuration module of the softAP computing device may receive a request for eMBMS MCAST traffic from a connected LAN client device and may notify the eMBMS modem of the computing device to enable the eMBMS modem to establish an eMBMS call to an eMBMS network to receive eMBMS MCAST traffic associated with the request from the connected LAN client device.

In an embodiment, the router configuration module of the softAP computing device may assign a self-assigned IP address to the WAN interface (e.g., a WWAN interface) of the kernel executing in a processor of the softAP computing device where the eMBMS MCAST traffic may be received from the eMBMS modem. A self-assigned IP address may be assigned to the WAN interface by the router configuration module because in current eMBMS networks, the network will not assign a unicast address to the softAP computing device for receipt of eMBMS multicast traffic. In an embodiment, the self-assigned IP address may be any valid static or dynamic IP address, such as any valid static or dynamic Internet Protocol version 4 (“IPv4”) IP address. In an embodiment, the self-assigned IP address may be assigned to the WAN interface by storing the self-assigned IP address in a memory of the softAP computing device, such as in a data table correlating interfaces with their respective IP addresses.

In an embodiment, the router configuration module may also indicate that that WAN interface with the assigned self-assigned IP address and the LAN interface to which the client device may be connected are both MCAST capable interfaces. For example, the router configuration module may set a flag in a memory of the softAP computing device indicating that the WAN interface and LAN interface are MCAST capable, such as by setting an MCAST capable flag to “yes” for both the LAN interface and WAN interface in the data table correlating interfaces with their respective IP addresses.

In an embodiment, the router configuration module may start an MCAST routing daemon/utility of the softAP computing device, for example in response to assigning a self-assigned IP address to a WAN interface and/or indicating that the WAN interface and LAN interface are MCAST capable. In an embodiment, the MCAST routing daemon/utility of the softAP computing device may generate MCAST routing rules indicating the IP address of the LAN interface and self-assigned IP address of the WAN interface, the MCAST capability of the LAN interface and the WAN interface, and the requirement to route eMBMS MCAST traffic received at the WAN interface on to the LAN interface. For example, the MCAST routing daemon/utility of the softAP computing device may generate a routing table indicating the IP address of the LAN interface and self-assigned IP address of the WAN interface, the MCAST capability of the LAN interface and the WAN interface, and the requirement to route eMBMS MCAST traffic received at the WAN interface on to the LAN interface. In an embodiment, initially the MCAST routing rules may remain internal to the MCAST routing daemon/utility and not sent to the kernel of the softAP computing device. In an embodiment, the MCAST routing daemon/utility of the softAP computing device may identify connected LAN client devices requesting eMBMS MCAST traffic and may update the MCAST routing rules (e.g., the routing table internal to the MCAST daemon/utility) to reflect the connected LAN client devices requesting eMBMS MCAST traffic. For example, the MCAST routing daemon/utility may process Internet Group Management Protocol (“IGMP”) JOIN packets from connected LAN client devices requesting membership to the an eMBMS MCAST traffic address to identify connected LAN client devices requesting eMBMS MCAST traffic and may update the MCAST routing rules (e.g., the routing table internal to the MCAST daemon/utility) to reflect the connected LAN client devices requesting eMBMS MCAST traffic.

When eMBMS MCAST traffic is initially received at the WAN interface, there may be no routes established between the WAN interface and LAN interface in a routing table of the kernel of the softAP computing device. The kernel of the softAP device may determine there are no routes established for the eMBMS MCAST traffic, and in response the kernel may provide the received eMBMS MCAST traffic to the MCAST routing daemon/utility of the soft AP computing device. In an embodiment, in response to receiving the eMBMS MCAST traffic from the kernel, the MCAST routing daemon/utility of the softAP computing device may identify the WAN interface for MCAST routing to LAN clients by installing MCAST routing rules in the kernel executing in a processor of the softAP computing device. In an embodiment, the MCAST routing daemon/utility of the softAP computing device may install MCAST routing rules in the kernel of the softAP computing device by creating and/or updating one or more routing tables of the kernel, such as one or more MCAST routing tables stored in a memory of the softAP computing device available to the kernel, to indicate the IP address of the LAN interface and self-assigned IP address of the WAN interface, the MCAST capability of the LAN interface and the WAN interface, and the requirement to route eMBMS MCAST traffic received at the WAN interface on to the LAN interface. For example, the MCAST routing daemon/utility may install its previously generate internal routing table indicating the IP address of the LAN interface and self-assigned IP address of the WAN interface, the MCAST capability of the LAN interface and the WAN interface, and the requirement to route eMBMS MCAST traffic received at the WAN interface on to the LAN interface and the connected LAN client devices requesting eMBMS MCAST traffic into the kernel. The MCAST routing daemon/utility may also send the eMBMS MCAST traffic back to the kernel for routing to the LAN interface and onto the requesting connected LAN client devices. The kernel of the softAP computing device may use the installed MCAST routing rules to route subsequent eMBMS MCAST traffic from the WAN interface to the LAN interface and onto the connected LAN client devices.

The MCAST routing daemon/utility may validate eMBMS traffic received at the WAN interface, for example by validating the source address of the eMBMS MCAST traffic is in the same subnet of the WAN interface. In various embodiments, an MCAST routing daemon/utility that executes in a processor of a softAP computing device may be modified to skip source validation, thereby enabling all eMBMS MCAST traffic to be forwarded to LAN clients regardless of the source address of the eMBMS MCAST traffic. In an embodiment, an MCAST routing daemon/utility may be modified to accept an alternate network comprising all source IP addresses. In an embodiment, the alternate network may be 0.0.0.0/0, which may comprise all source IP addresses. In this manner, even though the source address of any packets of eMBMS MCAST traffic received at the WAN interface may be of a different subnet than the WAN interface, any packets of the eMBMS MCAST traffic may be part of the alternate network of 0.0.0.0/0 encompassing all source IP addresses and may be identified as valid packets and routed from the WAN interface to the LAN interface. In an embodiment, the MCAST routing daemon/utility executing in a processor of the softAP computing device may be modified to indicate the alternate network encompassing all source IP addresses, such as an alternate network of 0.0.0.0/0, in a routing table of the kernel executing in a processor of the softAP computing device. In this manner, the modified MCAST routing daemon/utility may enable validating source addresses of packets of the eMBMS MCAST traffic against the indication of the alternate network as packets of eMBMS MCAST traffic. When the packets of the eMBMS MCAST traffic are received at the WAN interface, the packets may be initially validated by the MCAST routing daemon/utility as belonging to the alternate network and suitable for routing from the WAN interface to the LAN interface regardless of the source address of the packets of eMBMS MCAST traffic.

By enabling a softAP computing device to route evolved eMBMS MCAST traffic from a WAN interface to a LAN interface and onto connected LAN client devices, the various embodiments provide softAP computing devices with new and improved functions for client devices, namely delivering eMBMS MCAST traffic to client devices. The various embodiments may improve the functioning of softAP computing devices by enabling WAN interfaces to be identified by MCAST routing daemons/utilities and/or eMBMS MCAST traffic to be routed from WAN interfaces to LAN interfaces in a manner that is not available to current softAP computing devices. Additionally, the various embodiments may improve the functioning of softAP computing devices and/or MCAST routing daemons/utilities by enabling packets of eMBMS MCAST traffic from any source to be routed from WAN interfaces to LAN interfaces and onto connected LAN clients. The ability to route packets regardless of source address may improve the functioning of the softAP computing devices by reducing and/or eliminating packet loss due to source addressing issues of eMBMS MCAST traffic.

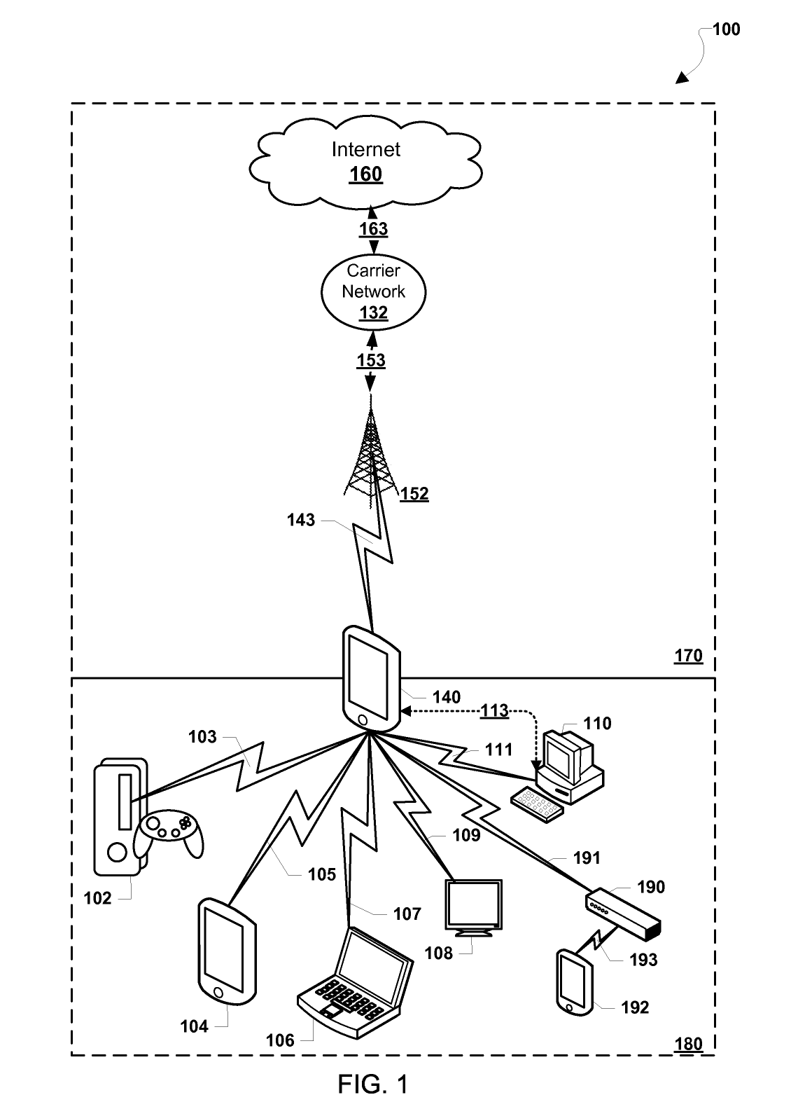

FIG. 1 illustrates a communication system 100 including a softAP computing device 140 in wireless communication with various devices. The softAP computing device 140 may be any computing device capable of executing applications, routines, logic, circuitry, units, modules, and/or other components for enabling software-enabled access point (or softAP router) functionalities. For example, the softAP computing device 140 may include Wi-Fi transceivers, eMBMS (i.e., LTE) chip(s)/modem(s), subscriber identity modules (SIMs or SIM cards), antenna, processor(s), memory(s), and other components that may enable the softAP computing device 140 to establish a LAN 180 (e.g., a Wi-Fi LAN) as well as communicate with various devices in a WAN 170. In particular, the softAP computing device 140 may include components for communicating via an eMBMS WAN connection 143 with base station 152 (e.g., an eNodeB) associated with an eMBMS carrier network 132.

The base station 152 may be connected to the eMBMS carrier network 132 via connection 153. The eMBMS carrier network 132 may in turn have connection 163 to the Internet 160. Via the base station 152 and eMBMS WAN connection 143 to the softAP computing device 140, the eMBMS carrier network 132 may provide eMBMS MCAST traffic to the softAP computing device 140.

Executing software for enabling a connectable software enabled access point (or software-enabled access point router), the softAP computing device 140 may be capable of providing a LAN 180 that may provide a plurality of client devices access to the various resources and/or devices via the WAN 170. In particular, the softAP computing device 140 may serve as a LAN router (or hub) that provides a WAN connection for various client devices having wireless connection capabilities (e.g., Wi-Fi, etc.), such as a game console 102 (e.g., Xbox 360®, Xbox One®, etc.), a smartphone 104 (or tablet device), a laptop computer 106, a television device 108 (e.g., a smart TV), a desktop computer 110 (or personal computer), and a local router device 190.

Each of the client devices 102, 104, 106, 108, 110, 190 may be configured to connect to the softAP computing device 140 via wired or wireless connections 103, 105, 107, 109, 111, 191. For example, the game console 102 may connect to the softAP computing device 140 via a first connection 103, the smartphone 104 may connect to the softAP computing device 140 via a second connection 105, the laptop computer 106 may connect to the softAP computing device 140 via a third connection 107, the television device 108 may connect to the softAP computing device 140 via a fourth connection 109, the desktop computer 110 may connect to the softAP computing device 140 via a fifth connection 111, and the local router device 190 may connect to the softAP computing device 140 via a sixth connection 111. As another example, the desktop computer 110 may connect to the softAP computing device 140 via a universal serial bus (USB) connection 113 instead of or in addition to connecting to the softAP computing device 140 via a Wi-Fi connection.

In various embodiments, the connections 103, 105, 107, 109, 111, 113, 191 may be wired (e.g., USB connections, etc.) or wireless (e.g., Wi-Fi connections, etc.). In some embodiments, the connections 103, 105, 107, 109, 111, 113, 191 may utilize various short-range or long-range wireless communication technologies, protocols, and/or standards, such as Bluetooth, Zigbee, Wi-Fi Direct, RF, etc. In some embodiments, the softAP computing device 140 may indirectly provide a WAN connection to other devices. In particular, the local router device 190 connected to the WAN 170 via the LAN 180 established by the softAP computing device 140 may in turn provide the WAN connection to another computing device 192 via a Wi-Fi, Bluetooth, or other wired or wireless connection. In the various embodiments, the connections 103, 105, 107, 109, 111, 113, 191 may enable the softAP computing device 140 to route eMBMS MCAST traffic received via the WAN 170 from the eMBMS carrier network 132 to the various client devices 102, 104, 106, 108, 110, 190 in the LAN 180.

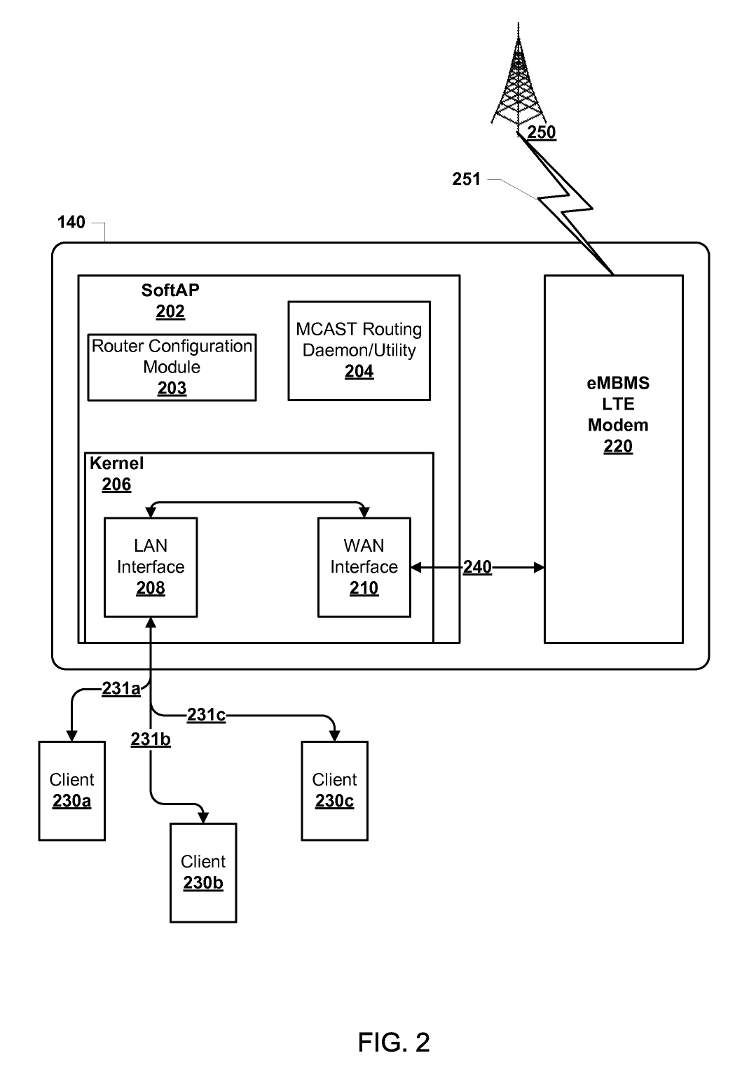

FIG. 2 illustrates modules within a softAP computing device 140 configured to operate as a softAP router to route eMBMS MCAST traffic to connected LAN devices according to the various embodiments. As described above, the softAP computing device 140 may include various components and functionalities for conducting communications with resources in a WAN. For example, the softAP computing device 140 may include antennas/transceivers configured to exchange communications with a base station 250 (e.g., an eNodeB) of an eMBMS network via a wireless wide area network (“WWAN”) connection 251 (e.g., an eMBMS connection). In this manner, the softAP computing device 140 may receive eMBMS MCAST traffic from the eMBMS network. The softAP computing device 140 may include various components and functionalities for establishing a LAN and conducting communications with resources connected to the LAN. For example, the softAP computing device may include a Wi-Fi transceiver configured to exchange signals with nearby LAN client devices 230a-230c via wireless connections 231a-231c (e.g., Wi-Fi communications, etc.).

The softAP computing device 140 may include an application processor 202 configured to execute various software applications, modules, routines, instructions, and other operations. The application processor 202 may be configured to execute a router configuration module 203 (or softAP router configuration module), an MCAST routing daemon/utility 204 (e.g., pimd, mrouted, etc.) and a kernel module 206 (e.g., an operating system kernel, such as Linux, Android, iOS, and/or Windows kernel). The kernel module 206 may be configured to enable various functionalities of the softAP computing device, such as operations for controlling a LAN interface module 208 for processing communications associated with a local area network (e.g., Wi-Fi communications with LAN client devices 230a-230c, etc.), as well as a WAN interface module 210.

The softAP computing device 140 may also include an eMBMS (i.e., LTE) modem including a modem processor 220 configured to execute and otherwise support various software modules for handling communications. In particular, the modem processor 220 may be configured to provide eMBMS MCAST traffic to the WAN interface module 210 of the application processor 202. The modem processor 220 and the application processor 202 may be connected via a bus 240 for exchanging data and various signaling between the processing units.

The following is an illustration of an interaction between the various components of the softAP computing device 140 for routing eMBMS MCAST traffic to a client device, such as client device 230a, 230b, and/or 230c, connected to the LAN established by the softAP computing device according to some embodiments.

LAN client devices 230a-230c may establish wireless connections 231a-231c with the softAP computing device 140 to establish a local area network. As the client devices 230a-230c connect to the LAN interface 208, the client devices 230a-230c may request eMBMS MCAST traffic, for example by subscribing to eMBMS MCAST services. The router configuration module 203 may listen for requests for eMBMS MCAST traffic and may notify the eMBMS modem 220 of a request for eMBMS MCAST traffic from one of the client devices 230a-230c. In response to being notified of the request for eMBMS MCAST traffic, the eMBMS modem 220 may establish a data connection, such as a WWAN connection 251 (e.g., an eMBMS connection) with an eMBMS network. Via the data connection, the eMBMS modem 220 may receive eMBMS MCAST traffic (e.g., packets of eMBMS MCAST traffic) and may provide the eMBMS MCAST traffic to the WAN interface 210.

In response to receiving requests for eMBMS MCAST traffic from the client devices 230a-230c, the router configuration module 203 may assign a self-assigned IP address to the WAN interface. The self-assigned IP address may be any type IP address, such as a static IPv4 address or a dynamic IPv4 address. The router configuration module 203 may also indicate the LAN interface 208 and the WAN interface 210 as MCAST capable. The router configuration module 203 may start the MCAST routing daemon/utility 204 which may generate MCAST routing rules to route eMBMS MCAST traffic from the WAN interface 210 to the LAN interface 208 based at least in part on the assigned self-assigned IP address from the router configuration module 203. In an embodiment, the generated MCAST routing rules may include an indication of an alternate network comprising all source IP addresses. For example, the indication of the alternate network may be 0.0.0.0/0. Additionally, the MCAST routing daemon/utility 204 may identify connected client devices 230a-230c requesting eMBMS MCAST traffic. The MCAST routing daemon/utility 204 may identify the connected client devices 230a-230c requesting eMBMS MCAST traffic based on information received from the router configuration module and/or by processing IGMP JOIN packets from the client devices 230a-230c. In an embodiment, the generated MCAST routing rules may identify the client devices 230a-230c requesting eMBMS MCAST traffic. In an embodiment, the MCAST routing daemon/utility 204 may store the MCAST routing rules internally, awaiting the arrival of initial eMBMS MCAST traffic to install the generated MCAST routing rules into the kernel 206.

The kernel 206 may not have MCAST routing rules installed/available initially. When eMBMS MCAST traffic is received at the WAN interface 210, the kernel 206 may determine whether MCAST routing rules are available. For example, the kernel 206 may determine whether a routing table with routes configured between the WAN interface 210 and LAN interface 208 is installed. In response to determining that MCAST routing rules are not installed/available, the kernel 206 may send the eMBMS MCAST traffic to the MCAST routing daemon/utility 204. The MCAST routing daemon/utility 204 may validate the eMBMS MCAST traffic and may send the MCAST routing rules and eMBMS MCAST traffic to the kernel 206 to install the generated MCAST routing rules into the kernel 206. For example, the MCAST routing daemon/utility 204 may install the generated MCAST routing rules into the kernel 206 including the LAN interface 208 and the WAN interface 210 by creating and/or updating a routing table of the kernel 206, such as an MCAST routing table, to indicate that eMBMS MCAST traffic is to be routed from the WAN interface 210 to the LAN interface. In this manner, as the eMBMS modem 220 provides the eMBMS MCAST traffic (e.g., packets of the eMBMS MCAST traffic) to the WAN interface 210, the eMBMS MCAST traffic may be routed by the kernel 206 from the WAN interface 210 to the LAN interface 208 and onto the client devices 230a-230c via the respective wireless connections 231a-231c. Additionally, because the MCAST routing rules may include the indication of the alternate network comprising all source IP addresses, such as the indication of the alternate network 0.0.0.0/0, each packet of the eMBMS MCAST traffic may be identified as having a valid source IP address and may be routed from the WAN interface 210 to the LAN interface 208 even though the source IP address of the packets of the eMBMS MCAST traffic and the WAN interface 210 self-assigned IP address may not be part of the same subnet.

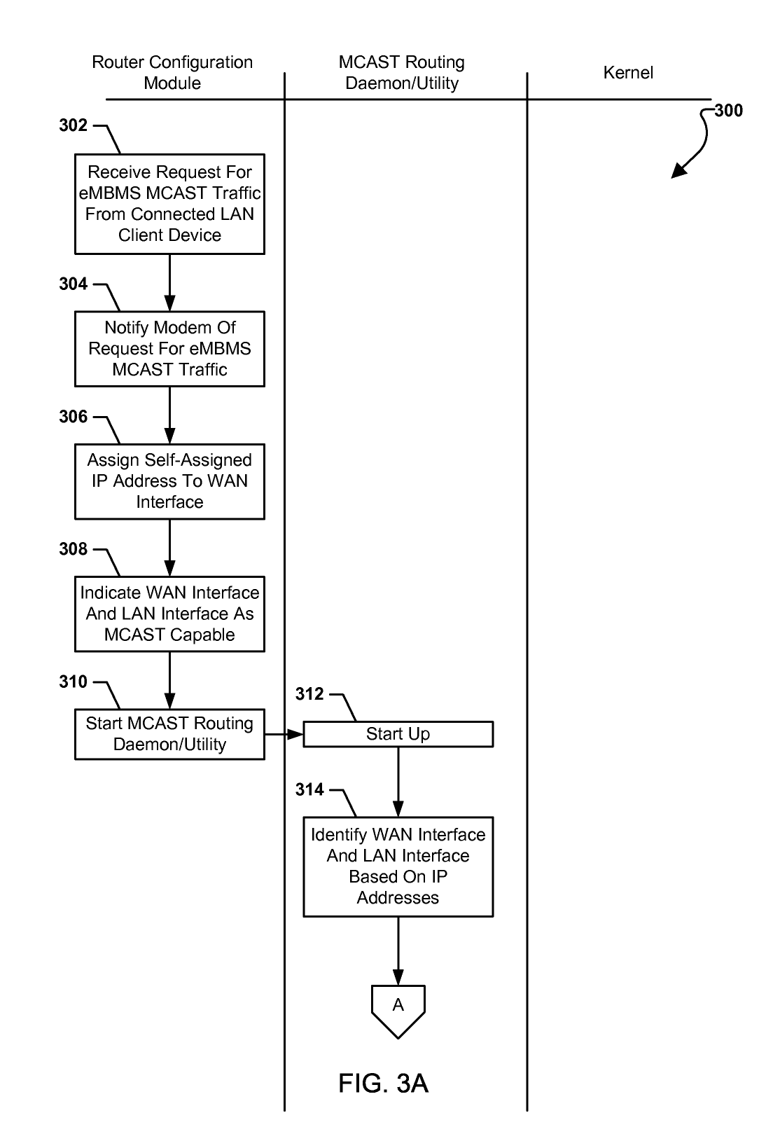

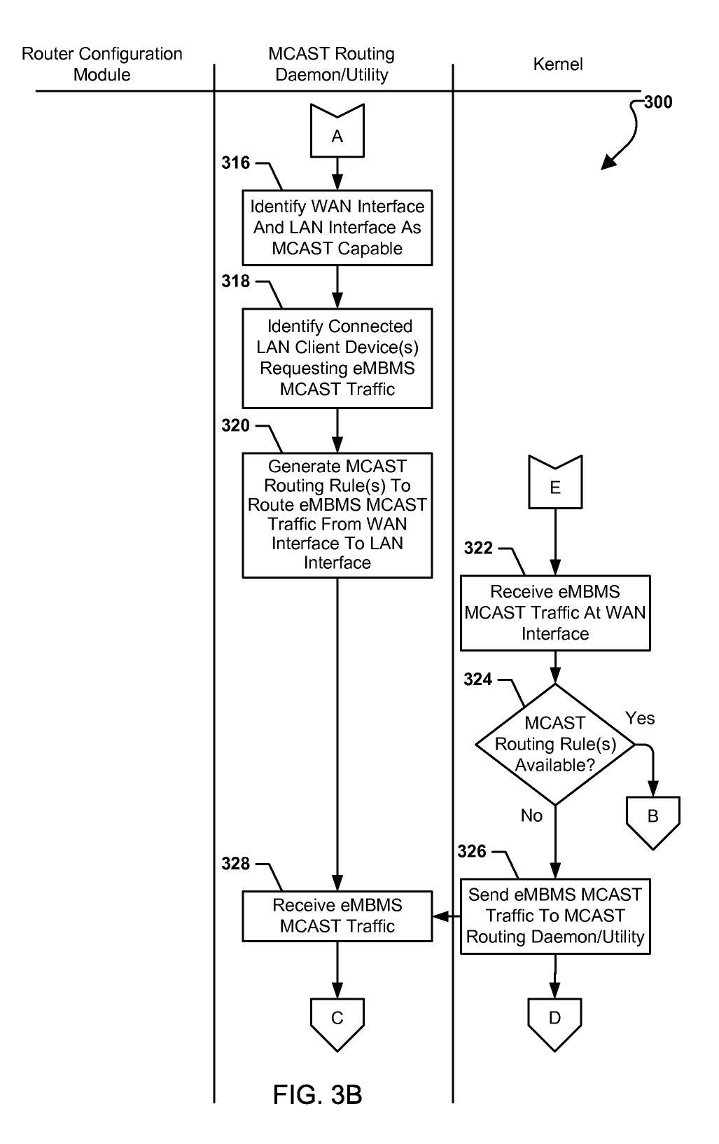

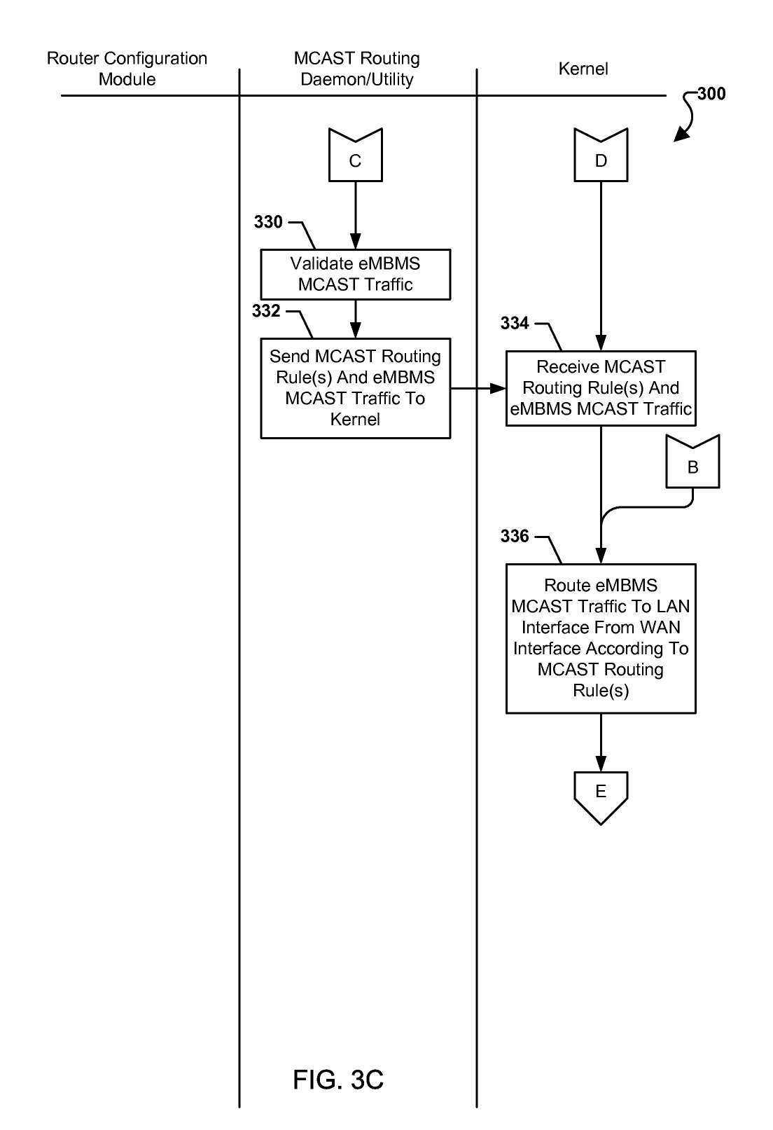

FIGS. 3A, 3B, and 3C illustrate an embodiment method 300 for a computing device configured to operate as a softAP to assign a self-assigned IP address to a WAN interface, install MCAST routing rules, and route eMBMS MCAST traffic to a LAN interface from the WAN interface. The operations of method 300 may be performed by various processors of the softAP computing device, such as an application processor.

In block 302 (FIG. 3A) the router configuration module of the softAP computing device may receive a request for eMBMS MCAST traffic from a connected LAN client device. In an embodiment, a client device may connect to the LAN interface of the softAP computing device, and the client device may request eMBMS MCAST traffic, such as by subscribing to eMBMS MCAST services available from an eMBMS network. The router configuration module may listen for requests for eMBMS MCAST traffic and receive the request for eMBMS MCAST traffic from the client device via the LAN interface.

In block 304 the router configuration module may notify the modem of the softAP computing device, such as an eMBMS modem, of the request for eMBMS MCAST traffic received from the connected LAN client device. In this manner, the modem may establish a data connection with an eMBMS network to receive the eMBMS MCAST traffic.

In block 306 the router configuration module may assign a self-assigned IP address to the WAN interface of the softAP computing device. As discussed above, the WAN interface of the softAP computing device may be an interface of the kernel of the softAP computing device that may receive eMBMS MCAST traffic from the modem. In an embodiment, the self-assigned IP address may be any valid static or dynamic IP address, such as any valid static or dynamic Internet Protocol version 4 (“IPv4”) IP address. In an embodiment, the self-assigned IP address may be assigned to the WAN interface by storing the self-assigned IP address in a memory of the softAP computing device, such as in a data table correlating interfaces with their respective IP addresses.

In block 308 the router configuration module may indicate that the WAN interface and the LAN interface of the softAP computing device are MCAST capable. For example, the router configuration module may set a flag in a memory of the softAP computing device indicating that the WAN interface and LAN interface are MCAST capable, such as by setting an MCAST capable flag to “yes” for both the LAN interface and WAN interface in the data table described above correlating interfaces with their respective IP addresses.

In block 310 the router configuration module may start an MCAST routing daemon/utility, and in block 312 the MCAST routing daemon/utility of the softAP computing device may start up. In this manner, the MCAST routing daemon/utility of the softAP computing device may be started in response to a request for eMBMS MCAST traffic from a connected LAN client device.

In block 314 the MCAST routing daemon/utility of the softAP computing device may identify the WAN interface and LAN interface based on the IP addresses assigned to both interfaces. In an embodiment, the MCAST routing daemon/utility of the softAP computing device may be configured to identify only interfaces with assigned IP addresses upon start up, and based on the IP address of the LAN interface and the self-assigned IP address assigned to the WAN interface by the router configuration module, the MCAST routing daemon/utility of the softAP computing device may identify the presence of both the LAN and the WAN interface. As an example, the MCAST routing daemon/utility of the softAP computing device may identify the available interfaces based on a data table stored in a memory of the softAP computing device, such as the data table described above correlating interfaces with their respective IP addresses updated by the router configuration module.

In block 316 (FIG. 3B) the MCAST routing daemon/utility of the softAP computing device may identify the WAN interface and LAN interface as MCAST capable. In this manner, the MCAST routing daemon/utility of the softAP computing device may identify that eMBMS MCAST traffic can be routed between the WAN interface and LAN interface. As an example, the MCAST routing daemon/utility of the softAP computing device may identify the WAN interface and LAN interface as MCAST capable based on indications in a data table stored in a memory of the softAP computing device, such as the data table described above correlating interfaces with their respective IP addresses updated by the router configuration module. In block 318 the MCAST routing daemon/utility of the softAP computing device may identify the connected LAN client devices requesting eMBMS MCAST traffic. For example, the MCAST routing daemon/utility may process Internet Group Management Protocol (“IGMP”) JOIN packets from connected LAN client devices requesting membership to an eMBMS MCAST traffic address to identify connected LAN client devices requesting eMBMS MCAST traffic.

In block 320 the MCAST routing daemon/utility of the softAP computing device may generate MCAST routing rules to route eMBMS MCAST traffic from the WAN interface to the LAN interface based at least in part on the assigned self-assigned IP address of the WAN interface. For example, the MCAST routing daemon/utility of the softAP computing device may generate MCAST routing rules by creating or updating a routing table to cause the routing table to indicate that eMBMS MCAST traffic packets received at the WAN interface should be routed to the LAN interface for transmission onto an identified connected LAN client. Additionally, the generated MCAST routing rules may include an indication of an alternate network that the MCAST routing daemon/utility may identify as a valid source IP address for packets of eMBMS MCAST traffic that may not be in the same subnet as the WAN interface. In an embodiment, the alternate network may encompass all source IP addresses, such as the indication of the alternate network 0.0.0.0/0. In this manner, the generated MCAST routing rules may enable each packet of the eMBMS MCAST traffic to be identified as having a valid source IP address and may be routed from the WAN interface to the LAN interface even though the source IP address of the packets of the eMBMS MCAST traffic and the WAN interface self-assigned IP address may not be part of the same subnet. In an embodiment, the generated MCAST routing rules, such as a MCAST routing table, may initially remain internal to the MCAST routing daemon/utility, for example by being stored in a memory available to the MCAST routing daemon/utility but not available to the kernel of the softAP mobile computing device.

In block 322 the kernel executing in a processor of the softAP computing device may receive eMBMS MCAST traffic at the WAN interface. For example, the kernel executing in a processor of the softAP computing device may receive eMBMS MCAST traffic (e.g., packets of the eMBMS MCAST traffic) at the WAN interface from the modem, such as an eMBMS modem. In determination block 324 the kernel executing in a processor of the softAP computing device may determine whether MCAST routing rules are available to the kernel. For example, the kernel may determine whether a MCAST routing table is present in a memory available to the kernel. Initially MCAST routing rules (e.g., routing tables) for eMBMS MCAST traffic may not be configured in the kernel and when MCAST routing rules are not available/installed the kernel may take different actions than when MCAST routing rules are available/installed. In response to determining that MCAST routing rules are not available (i.e., determination block 324=“No”), the kernel may send the eMBMS MCAST traffic to the MCAST routing daemon/utility executing in a processor of the softAP computing device in block 326, and the MCAST routing daemon/utility may receive the eMBMS MCAST traffic in block 328.

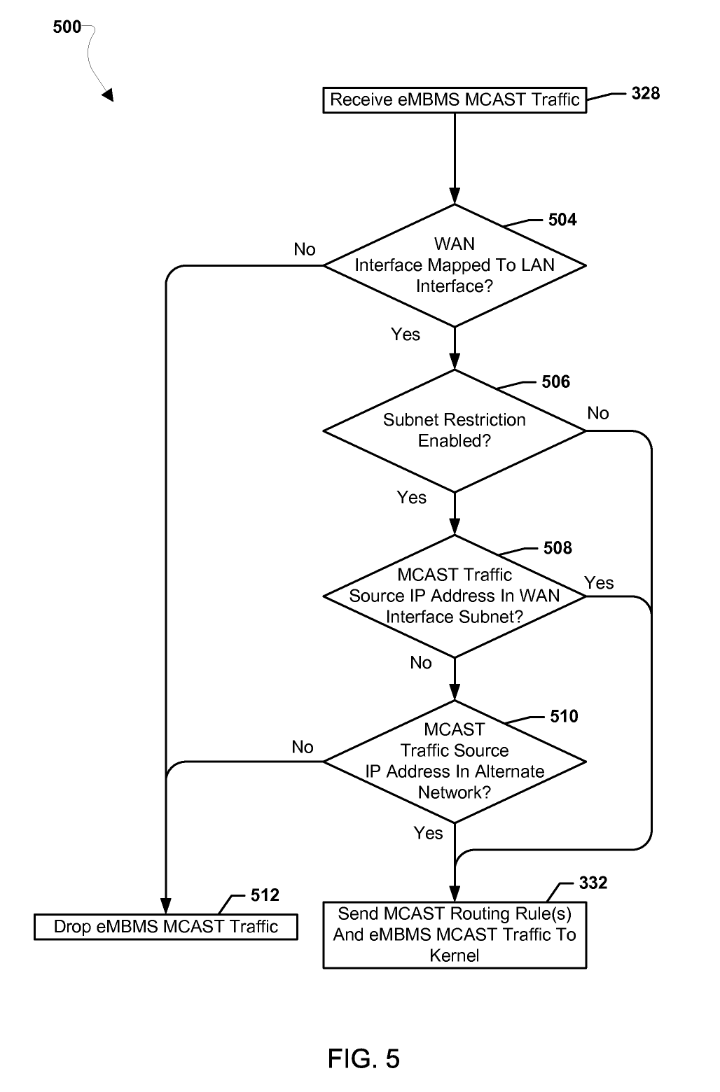

In block 330 (FIG. 3C), the MCAST routing daemon/utility executing in the processor of the softAP computing device may validate the eMBMS MCAST traffic. The MCAST routing daemon/utility may validate eMBMS traffic received at the WAN interface, for example by validating the source address of the eMBMS MCAST traffic is in the same subnet of the WAN interface. In various embodiments, an MCAST routing daemon/utility executing in the processor of a softAP computing device may be modified to accept an alternate network comprising all source IP addresses. In an embodiment, the alternate network may be 0.0.0.0/0, which may encompass all source IP addresses. Validation of the eMBMS MCAST traffic by the MCAST routing daemon/utility may ensure only validated eMBMS MCAST traffic is routed between the WAN interface and LAN interface. Validation of eMBMS MCAST traffic by the MCAST routing daemon/utility is discussed further below with reference to FIG. 5.

In block 332 the MCAST routing daemon/utility executing in a processor of the softAP computing device may send the MCAST routing rules and eMBMS MCAST traffic to the kernel executing in a processor of the softAP computing device, and in block 334 the kernel may receive the MCAST routing rules and eMBMS MCAST traffic. In this manner, the MCAST routing daemon/utility of the softAP computing device may install the generated MCAST routing rules into the kernel of the softAP computing device including the LAN interface and the WAN interface. For example, the MCAST routing daemon/utility may install the generated MCAST routing rules into the kernel by creating and/or updating a routing table of the kernel, such as an MCAST routing table, to indicate that eMBMS MCAST traffic is to be routed from the WAN interface to the LAN interface and onto the identified connected LAN clients requesting the eMBMS MCAST traffic.

Upon receiving the MCAST routing rules and eMBMS MCAST traffic in block 334, or in response to determining MCAST routing rules are available (i.e., determination block 324=“Yes”), in block 336 the kernel executing in a processor of the softAP computing device may route the eMBMS MCAST traffic to the LAN interface from the WAN interface according to the MCAST routing rules. For example, the kernel may reference a routing table as the packets of the eMBMS MCAST traffic are received that indicates packets of the eMBMS MCAST traffic are to be routed from the WAN interface to the LAN interface and based on the indication in the routing table may route the received packets of the eMBMS MCAST traffic from the WAN interface to the LAN interface. Additionally, because the MCAST routing rules, such as the routing table, may include the indication of the alternate network encompassing all source IP addresses (e.g., 0.0.0.0/0), each packet of the eMBMS MCAST traffic may be identified as having a valid source IP address allowing the packets to be routed from the WAN interface to the LAN interface, regardless of their source IP addresses. In an embodiment, the method 300 may return to block 322 (FIG. 3B) to continually receive eMBMS MCAST traffic at the WAN interface and route the eMBMS traffic to the LAN interface.

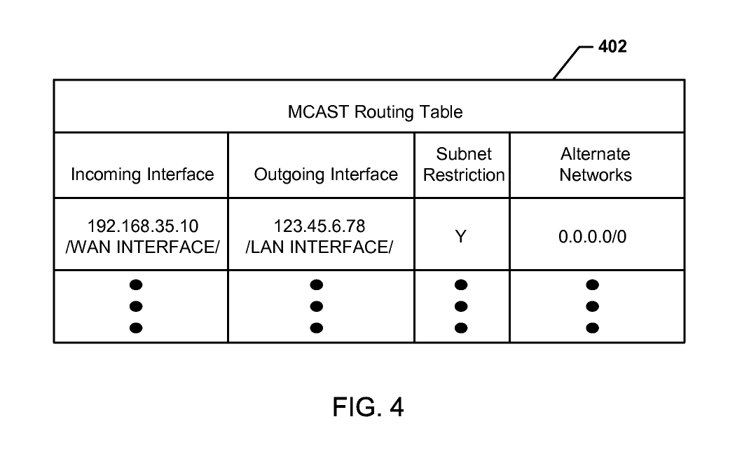

FIG. 4 is a data structure diagram of an MCAST routing table 402 illustrating example data fields according to an embodiment. In an embodiment, the MCAST routing table 402 may be stored in a memory of a softAP computing device and may be available initially to a MCAST routing daemon/utility and later installed in a kernel executing in a processor of the softAP computing device. In an embodiment, the MCAST routing table 402 may include MCAST routing rules generated by an MCAST routing daemon/utility to control how a kernel routes received packets among interfaces, such as a WAN interface and LAN interface. In an embodiment, the fields of the MCAST routing table 402 may be updated by the outer configuration module, MCAST routing daemon/utility, and/or kernel executing in a processor of the softAP computing device. In an embodiment, the listing of the IP address of an interface in the MCAST routing table 402 may be an indication that the interface is MCAST capable.

In an embodiment, the MCAST routing table 402 may indicate an incoming interface where packets of eMBMS MCAST traffic may be received, for example by an IP address of the incoming interface, such as “192.168.35.10,” and/or by a label, such as “WAN INTERFACE.” In an embodiment, the MCAST routing table 402 may indicate an outgoing interface to which packets of eMBMS MCAST traffic may be routed, for example by an IP address of the outgoing interface, such as “123.45.6.78,” and/or by a label, such as “LAN INTERFACE.” In an embodiment, the incoming interface and outgoing interface may be correlated in the MCAST routing table 402, thereby indicating that packets should be routed from the IP address associated with the incoming interface to the IP address associated with the outgoing interface.

In an embodiment, a subnet restriction flag may be included in the MCAST routing table 402. For example, a “Y” in the subnet restriction flag may indicate the source IP address of any packets received at the incoming interface must be validated prior to routing the packets to the outgoing interface. Validation may include comparing the source IP address of each received packet to the subnet of the incoming interface and/or any alternate network indicated in the MCAST routing table 402. Only those received packets with the same subnet as the incoming interface or the alternate network indicated in the MCAST routing tabled 402 may be valid and may be routed from the incoming interface to the outgoing interface. In an embodiment, the subnet restriction flag and alternate networks may be correlated with the incoming interfaces and outgoing interfaces to indicate the incoming interface and outgoing interface pairing to which the subnet restriction flag and alternate networks may apply.

FIG. 5 illustrates an embodiment method 500 for a computing device configured to operate as a softAP to validate eMBMS MCAST traffic. The operations of the method 500 may be performed by various processors of the softAP computing device, such as an application processor. In an embodiment, the operations of method 500 may include the operations of block 330 of method 300 described above and performed by a MCAST routing daemon/utility to validate eMBMS MCAST traffic.

As described above, in block 324 the MCAST routing daemon/utility may receive the eMBMS MCAST traffic (e.g., packets of eMBMS MCAST traffic) received at the WAN interface from the kernel. In determination block 504 the MCAST routing daemon/utility executing in a processor of the softAP computing device may determine whether the WAN interface is mapped to the LAN interface. For example, the MCAST routing daemon/utility may reference a routing table, such as MCAST routing table 402 described above, to determine whether the WAN interface is correlated a LAN interface. In response to determining that the WAN interface is not mapped to the LAN interface (i.e., determination block 504=“No”), the MCAST routing daemon/utility executing in a processor of the softAP computing device may drop the MCAST traffic in block 512.

In response to determining that the WAN interface is mapped to the LAN interface (i.e., determination block 504=“Yes”), the MCAST routing daemon/utility executing in a processor of the softAP computing device may determine whether a subnet restriction is enabled in determination block 506. As discussed above, a subnet restriction may be an MCAST routing rule requiring source IP addresses of packets of eMBMS MCAST traffic to be in the same subnet as the WAN interface or be associated with an indicated alternate network before the packets may be routed from the WAN interface. A subnet restriction may be indicated in a routing table internal to the MCAST routing daemon/utility. In response to determining no subnet restriction is enabled (i.e., determination block 506=“No”), the MCAST routing daemon/utility executing in a processor of the softAP computing device may send the MCAST routing rules and eMBMS MCAST traffic to kernel in block 332 as described above with reference to method 300.

In response to determining that the subnet restriction is enabled (i.e., determination block 506=“Yes”), the MCAST routing daemon/utility executing in a processor of the softAP computing device may determine whether the MCAST traffic source IP address is in the WAN interface's subnet in determination block 508. In response to determining that the source IP address of the eMBMS MCAST traffic is in the same subnet as the WAN interface (i.e., determination block 508=“Yes”), the MCAST routing daemon/utility executing in a processor of the softAP computing device may send the MCAST routing rules and eMBMS MCAST traffic to kernel in block 332 as described above with reference to method 300.

In response to determining that the source IP address of the eMBMS MCAST traffic is not in the same subnet as the WAN interface (i.e., determination block 508=“No”), the MCAST routing daemon/utility executing in a processor of the softAP computing device may determine whether the MCAST traffic source IP address is in the alternate network in determination block 510. In an embodiment, the alternate network may encompass all IP source addresses, such as an alternate network of 0.0.0.0/0, and may be indicated in a routing table available to the MCAST routing daemon/utility, such as an MCAST routing table. By determining whether the source IP address of the eMBMS MCAST traffic is in the alternate network the kernel may validate the source addresses of packets of the eMBMS MCAST traffic against the indication of the alternate network.

In response to determining that the source IP address of the eMBMS MCAST traffic is not in alternate network (i.e., determination block 510=“No”), the MCAST routing daemon/utility executing in a processor of the softAP computing device may drop the MCAST traffic in block 512. In response to determining that the source IP address of the eMBMS MCAST traffic is in alternate network (i.e., determination block 510=“Yes”), the MCAST routing daemon/utility executing in a processor of the softAP computing device may send the MCAST routing rules and eMBMS MCAST traffic to kernel in block 332 as described above with reference to method 300.

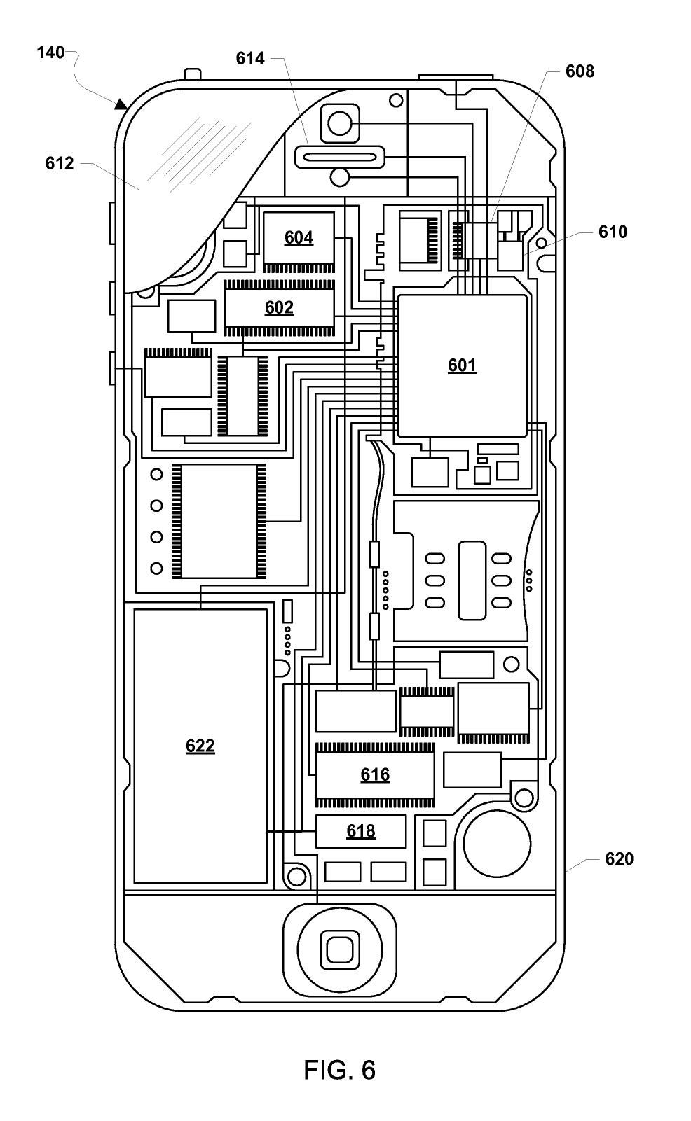

Various embodiments may be implemented in any of a variety of computing devices. For example, FIG. 6 illustrates a computing device 140 suitable for use in various embodiments. In various embodiments, the computing device 140 may include a processor 601 coupled to a touch screen controller 604 and an internal memory 602. The processor 601 may be one or more multicore ICs designated for general or specific processing tasks. The internal memory 602 may be volatile or non-volatile memory, and may also be secure and/or encrypted memory, or unsecure and/or unencrypted memory, or any combination thereof. The touch screen controller 604 and the processor 601 may also be coupled to a touch screen panel 612, such as a resistive-sensing touch screen, capacitive-sensing touch screen, infrared sensing touch screen, etc. The computing device 140 may have one or more radio signal transceivers 608 (e.g., Peanut®, Bluetooth®, Zigbee®, Wi-Fi, RF, cellular, etc.) and antennae 610, for sending and receiving, coupled to each other and/or to the processor 601. The transceivers 608 and antennae 610 may be used with the above-mentioned circuitry to implement the various wireless transmission protocol stacks and interfaces. The computing device 140 may include a cellular network wireless modem chip 616 that enables communication via a cellular network, such as an eMBMS network, and is coupled to the processor. The computing device 140 may include a peripheral device connection interface 618 coupled to the processor 601. The peripheral device connection interface 518 may be singularly configured to accept one type of connection, or multiply configured to accept various types of physical and communication connections, common or proprietary, such as USB, FireWire, Thunderbolt, or PCIe. The peripheral device connection interface 618 may also be coupled to a similarly configured peripheral device connection port (not shown). The computing device 140 may also include speakers 614 for providing audio outputs. The computing device 140 may also include a housing 620, constructed of a plastic, metal, or a combination of materials, for containing all or some of the components discussed herein. The computing device 140 may include a power source 622 coupled to the processor 601, such as a disposable or rechargeable battery. The rechargeable battery may also be coupled to the peripheral device connection port to receive a charging current from a source external to the computing device 140.

Processors of computing devices suitable for use in various embodiments may be any programmable microprocessor, microcomputer or multiple processor chip or chips that can be configured by software instructions (applications) to perform a variety of functions, including the functions of the various embodiments described above. In the various devices, multiple processors may be provided, such as one processor dedicated to wireless communication functions and one processor dedicated to running other applications. Typically, software applications may be stored in internal memory before they are accessed and loaded into the processors. The processors may include internal memory sufficient to store the application software instructions. In many devices, the internal memory may be a volatile or nonvolatile memory, such as flash memory, or a mixture of both. For the purposes of this description, a general reference to memory refers to memory accessible by the processors including internal memory or removable memory plugged into the various devices and memory within the processors.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a non-transitory processor-readable, computer-readable, or server-readable medium or a non-transitory processor-readable storage medium. The steps of a method or algorithm disclosed herein may be embodied in a processor-executable software module or processor-executable instructions (or software instructions) that may reside on a non-transitory computer-readable storage medium, a non-transitory server-readable storage medium, and/or a non-transitory processor-readable storage medium. In various embodiments, such instructions may be stored processor-executable instructions or stored processor-executable software instructions. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory processor-readable storage medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for routing evolved Multimedia Broadcast Multicast Service (“eMBMS”) multicast (“MCAST”) traffic to a client device connected to a local area network (“LAN”) established by a software enabled access point (“softAP”) computing device, comprising:
assigning, by a router configuration module executing in a processor of the softAP computing device, a self-assigned Internet Protocol (“IP”) address to a wide area network (“WAN”) interface of the softAP computing device;
generating, by a MCAST routing daemon executing in a processor of the softAP computing device, MCAST routing rules to route eMBMS MCAST traffic from the WAN interface to the LAN interface based at least in part on the assigned self-assigned IP address; and
routing, by the softAP computing device, eMBMS MCAST traffic from the WAN interface to the LAN interface according to the generated MCAST routing rules.

2. The method of claim 1, further comprising indicating, by the router configuration module executing in a processor of the softAP computing device, that the LAN interface and the WAN interface of the softAP computing device are MCAST capable.

3. The method of claim 1, wherein:
the generated MCAST routing rules include an indication of an alternate network comprising all source IP addresses; and
routing, by the softAP computing device, eMBMS MCAST traffic from the WAN interface to the LAN interface according to the generated MCAST routing rules comprises validating source addresses of packets of the eMBMS MCAST traffic against the indication of the alternate network.

4. The method of claim 3, wherein the indication of the alternate network is 0.0.0.0/0.

5. The method of claim 4, further comprising installing, by the MCAST routing daemon executing in a processor of the softAP computing device, the generated MCAST routing rules into a kernel executing in a processor of the softAP computing device including the LAN interface and the WAN interface,
wherein routing, by the softAP computing device, eMBMS MCAST traffic from the WAN interface to the LAN interface according to the generated MCAST routing rules comprises routing, by the kernel executing in a processor of the softAP computing device, eMBMS MCAST traffic from the WAN interface to the LAN interface according to the generated MCAST routing rules.

6. The method of claim 5, wherein installing, by the MCAST routing daemon executing in a processor of the softAP computing device, the generated MCAST routing rules into a kernel executing in a processor of the softAP computing device including the LAN interface and the WAN interface comprises installing, by the MCAST routing daemon executing in a processor of the softAP computing device, the generated MCAST routing rules into a kernel executing in a processor of the softAP computing device including the LAN interface and the WAN interface by updating a routing table of the kernel to indicate that eMBMS MCAST traffic is to be routed from the WAN interface to the LAN interface.

7. The method of claim 1, wherein the self-assigned IP address is a static IP version 4 (“IPv4”) address.

8. A software enabled access point (“softAP”) computing device, comprising a processor configured with processor-executable instructions to perform operations comprising:
assigning a self-assigned Internet Protocol (“IP”) address to a wide area network (“WAN”) interface of the softAP computing device;
generating MCAST routing rules to route eMBMS MCAST traffic from the WAN interface to the LAN interface based at least in part on the assigned self-assigned IP address; and
routing eMBMS MCAST traffic from the WAN interface to the LAN interface according to the generated MCAST routing rules.

9. The softAP computing device of claim 8, wherein the processor is configured with processor-executable instructions to perform operations further comprising indicating that the LAN interface and the WAN interface of the softAP computing device are MCAST capable.

10. The softAP computing device of claim 8, wherein the processor is configured with processor-executable instructions to perform operations such that:
the generated MCAST routing rules include an indication of an alternate network comprising all source IP addresses; and
routing eMBMS MCAST traffic from the WAN interface to the LAN interface according to the generated MCAST routing rules comprises validating source addresses of packets of the eMBMS MCAST traffic against the indication of the alternate network.

11. The softAP computing device of claim 10, wherein the indication of the alternate network is 0.0.0.0/0.

12. The softAP computing device of claim 11, wherein the processor is configured with processor-executable instructions to perform operations further comprising installing the generated MCAST routing rules into a kernel including the LAN interface and the WAN interface,
wherein the processor is configured with processor-executable instructions to perform operations such that routing eMBMS MCAST traffic from the WAN interface to the LAN interface according to the generated MCAST routing rules comprises routing, by the kernel, eMBMS MCAST traffic from the WAN interface to the LAN interface according to the generated MCAST routing rules.

13. The softAP computing device of claim 12, wherein the processor is configured with processor-executable instructions to perform operations such that installing the generated MCAST routing rules into a kernel including the LAN interface and the WAN interface comprises installing the generated MCAST routing rules into a kernel including the LAN interface and the WAN interface by updating a routing table of the kernel to indicate that eMBMS MCAST traffic is to be routed from the WAN interface to the LAN interface.

14. The softAP computing device of claim 8, wherein the self-assigned IP address is a static IP version 4 (“IPv4”) address.

15. A software enabled access point (“softAP”) computing device, comprising:
means for assigning a self-assigned Internet Protocol (“IP”) address to a wide area network (“WAN”) interface of the softAP computing device;
means for generating MCAST routing rules to route eMBMS MCAST traffic from the WAN interface to the LAN interface based at least in part on the assigned self-assigned IP address; and
means for routing eMBMS MCAST traffic from the WAN interface to the LAN interface according to the generated MCAST routing rules.

16. The softAP computing device of claim 15, further comprising means for indicating that the LAN interface and the WAN interface of the softAP computing device are MCAST capable.

17. The softAP computing device of claim 15, wherein:
the generated MCAST routing rules include an indication of an alternate network comprising all source IP addresses; and
means for routing eMBMS MCAST traffic from the WAN interface to the LAN interface according to the generated MCAST routing rules comprises means for validating source addresses of packets of the eMBMS MCAST traffic against the indication of the alternate network.

18. The softAP computing device of claim 17, wherein the indication of the alternate network is 0.0.0.0/0.

19. The softAP computing device of claim 18, further comprising means for installing the generated MCAST routing rules into a kernel including the LAN interface and the WAN interface,
wherein means for routing eMBMS MCAST traffic from the WAN interface to the LAN interface according to the generated MCAST routing rules comprises means for routing, by the kernel, eMBMS MCAST traffic from the WAN interface to the LAN interface according to the generated MCAST routing rules.

20. The softAP computing device of claim 19, wherein means for installing the generated MCAST routing rules into a kernel including the LAN interface and the WAN interface comprises means for installing the generated MCAST routing rules into a kernel including the LAN interface and the WAN interface by updating a routing table of the kernel to indicate that eMBMS MCAST traffic is to be routed from the WAN interface to the LAN interface.

21. The softAP computing device of claim 15, wherein the self-assigned IP address is a static IP version 4 (“IPv4”) address.

22. A non-transitory processor-readable storage medium having stored thereon processor-executable instructions configured to cause a processor of a software enabled access point (“softAP”) computing device to perform operations comprising:
assigning a self-assigned Internet Protocol (“IP”) address to a wide area network (“WAN”) interface of the softAP computing device;
generating MCAST routing rules to route eMBMS MCAST traffic from the WAN interface to the LAN interface based at least in part on the self-assigned IP address; and
routing eMBMS MCAST traffic from the WAN interface to the LAN interface according to the generated MCAST routing rules.

23. The non-transitory processor-readable storage medium of claim 22, wherein the stored processor-executable instructions are configured to cause a processor of a softAP computing device to perform operations further comprising indicating that the LAN interface and the WAN interface of the softAP computing device are MCAST capable.

24. The non-transitory processor-readable storage medium of claim 22, wherein the stored processor-executable instructions are configured to cause a processor of a softAP computing device to perform operations such that:
the generated MCAST routing rules include an indication of an alternate network comprising all source IP addresses; and
routing eMBMS MCAST traffic from the WAN interface to the LAN interface according to the generated MCAST routing rules comprises validating source addresses of packets of the eMBMS MCAST traffic against the indication of the alternate network.

25. The non-transitory processor-readable storage medium of claim 24, wherein the stored processor-executable instructions are configured to cause a processor of a softAP computing device to perform operations such that the indication of the alternate network is 0.0.0.0/0.

26. The non-transitory processor-readable storage medium of claim 25, wherein the stored processor-executable instructions are configured to cause a processor of a softAP computing device to perform operations further comprising installing the generated MCAST routing rules into a kernel including the LAN interface and the WAN interface,
wherein the stored processor-executable instructions are configured to cause a processor of a softAP computing device to perform operations such that routing eMBMS MCAST traffic from the WAN interface to the LAN interface according to the generated MCAST routing rules comprises routing, by the kernel, eMBMS MCAST traffic from the WAN interface to the LAN interface according to the generated MCAST routing rules.

27. The non-transitory processor-readable storage medium of claim 26, wherein the stored processor-executable instructions are configured to cause a processor of a softAP computing device to perform operations such that installing the generated MCAST routing rules into a kernel including the LAN interface and the WAN interface comprises installing the generated MCAST routing rules into a kernel including the LAN interface and the WAN interface by updating a routing table of the kernel to indicate that eMBMS MCAST traffic is to be routed from the WAN interface to the LAN interface.

28. The non-transitory processor-readable storage medium of claim 22, wherein the stored processor-executable instructions are configured to cause a processor of a softAP computing device to perform operations such that the self-assigned IP address is a static IP version 4 (“IPv4”) address.
